(19) United States
(12) Patent Application Publication
(10) Pub. No.: US 2010/0098329 A1
(43) Pub. Date: Apr. 22, 2010

(54) IMAGE PROCESSING METHOD AND IMAGE FORMING APPARATUS USING THE SAME

(75) Inventors: Tae-hong JANG, Seoul (KR); Jeong-hwan SHIN, Suwon-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/502,385

(22) Filed: Jul. 14, 2009

(30) Foreign Application Priority Data
Oct. 16, 2008 (KR) 10-2008-0101696

(51) Int. Cl. G06K 9/00

(52) U.S. Cl. 382/162

(57) ABSTRACT

An image processing method of converting a gray image into a halftone image, and an image forming apparatus using the same, the image processing method including: calculating critical values of a halftone table in positions of the halftone table from an initial pattern that has a smaller storage size than that of the halftone table, the halftone table corresponding to at least one pixel of the gray image; and creating the halftone image by applying a halftone process to pixels of the gray image on the basis of the calculated critical values of the halftone table. Accordingly, a memory used to store a halftone table is decreased, thereby reducing a cost of the memory, minimizing restriction on design, and speeding a halftone process up.

### CROSS-REFERENCE TO RELATED APPLICATION

This application claims the benefit of Korean Application No. 10-2008-0101696, filed Oct. 16, 2008 in the Korean Intellectual Property Office, the disclosure of which is incorporated herein by reference.

### BACKGROUND OF THE INVENTION

1. Field of the Invention

Aspects of the present invention relate to an image processing method and an image forming apparatus using the same, and more particularly, to an image processing method of performing a halftone process to convert a gray image into a halftone image and an image forming apparatus using the same.

2. Description of the Related Art

While an image forming apparatus (such as a printer, a copier, a multifunction printer, etc.) performs printing, a gray image is processed into a halftone image. Such a halftone process is carried out using a halftone table having a plurality of preset critical values. The halftone table is previously stored in a predetermined memory of the image forming apparatus.

In order to enhance the quality of printing, a memory size used to store the halftone table is increased. For example, a memory size used for a multi-bit halftone is several to several tens times greater than that for a single-bit halftone. As a result, the physical size of the memory becomes larger, which may increase cost and difficulties in design.

Furthermore, the halftone table is transmitted from an external memory (such as a dynamic random access memory (DRAM)) to an internal memory (such as a static random access memory (SRAM)) when fulfilling the halftone process. If the size of the halftone table increases, time taken to transmit the halftone also becomes longer, thereby lowering the speed of the halftone process.

### SUMMARY OF THE INVENTION

Aspects of the present invention provide an image processing method and an image forming apparatus using the same, in which a memory used to store a halftone table is decreased to thereby reduce a cost of the memory, minimize restriction on design, and speed a halftone process up.

According to an aspect of the present invention, there is provided an image processing method of converting a gray image into a halftone image, the image processing method including: calculating, by a computer, critical values of a halftone table in positions of the halftone table from an initial pattern that has smaller storage size than that of the halftone table, the halftone table corresponding to at least one pixel of the gray image; and creating, by the computer, the halftone image by applying a halftone process to pixels of the gray image on the basis of the calculated critical values of the halftone table.

The halftone image may include a single-bit halftone image, and the halftone table may include a single-bit halftone table corresponding to the single-bit halftone image.

The calculating of the critical values may include applying a scaling process to an initial value of the initial pattern, using a scaling factor corresponding to a bit level of the gray image to create a scaled initial pattern.

The calculating of the critical value of the single-bit halftone table may include extending the scaled initial pattern, by one or more steps, based on a critical-value calculating equation determined for a critical value, of the critical values of the halftone table, according to where the critical value is positioned on the single-bit halftone table.

The halftone image may include a multi-bit halftone image, the halftone table may include a plurality of multi-bit halftone tables corresponding to the multi-bit halftone image, and the calculating of the critical value of the halftone table may include calculating the critical values of the plurality of multi-bit halftone tables using the calculated critical values of a single-bit halftone table.

The calculating of the critical values of the plurality of multi-bit halftone tables may include interpolating a pair of critical values of the single-bit halftone table.

The pair of critical values may include a first critical value of the single-bit halftone table corresponding to a position of a critical value to be calculated, and a second critical value next in value to the first critical value.

The calculating of the critical values of the plurality of multi-bit halftone tables may further include determining a plurality of corresponding critical values of a same position on the plurality of respective multi-bit halftone tables to be distributed between the first critical value and the second critical value corresponding to the same position.

According to another aspect of the present invention, there is provided an image forming apparatus to convert a gray image into a halftone image, the image forming apparatus including: a halftone processing unit to calculate critical values of a halftone table in positions of the halftone table from an initial pattern that has a smaller storage size than that of the halftone table, the halftone table corresponding to at least one pixel of the gray image, and to create the halftone image by applying a halftone process to pixels of the gray image on the basis of the calculated critical values of the halftone table; and an image forming unit to form an image on a print medium according to the halftone image created by the halftone processing unit.

The halftone image may include a single-bit halftone image, and the halftone table may include a single-bit halftone table corresponding to the single-bit halftone image.

The halftone processing unit may apply a scaling process to an initial value of the initial pattern, using a scaling factor corresponding to a bit level of the gray image to create a scaled initial pattern.

The halftone processing unit may extend the scaled initial pattern, by one or more steps, based on a critical-value calculating equation determined for a critical value, of the critical values of the halftone table, according to where the critical value is positioned on the single-bit halftone table.

The halftone image may include a multi-bit halftone image, the halftone table may include a plurality of multi-bit halftone tables corresponding to the multi-bit halftone image, and the halftone processing unit may calculate the critical values of the plurality of multi-bit halftone tables using critical values of a single-bit halftone table.

The halftone processing unit may interpolate a pair of critical values of the single-bit halftone table.

The pair of critical values for the interpolation may include a first critical value of the single-bit halftone table corresponding to a position of a critical value to be calculated, and a second critical value next in value to the first critical value.

The halftone processing unit may determine a plurality of corresponding critical values of a same position on the plurality of respective multi-bit halftone tables to be distributed between the first critical value and the second critical value corresponding to the same position.

According to still another aspect of the present invention, there is provided an image processing method of converting a gray image into a halftone image through a processor, the image processing method including: calculating critical values of a halftone table corresponding to at least one pixel of the gray image by internal operations of the processor; and creating the halftone image by applying a halftone process to pixels of the gray image, using the calculated critical values of the halftone table.

The calculating of the critical value of the halftone table may include calculating the critical values of the halftone table from an initial pattern having a smaller storage size than that of the halftone table.

The calculating of the critical value of the halftone table may include: calculating critical values of a single-bit halftone table; and calculating critical values of a multi-bit halftone table from the calculated critical value of the single-bit halftone table.

According to yet another aspect of the present invention, there is provided an image forming apparatus to convert a gray image into a halftone image, the image forming apparatus including: a processor to calculate critical values of a halftone table corresponding to at least one pixel of the gray image and to create the halftone image by applying a halftone process to pixels of the gray image, using the calculated critical values of the halftone table; and an image forming unit to form an image on a print medium according to the created halftone image.

The processor may calculate the critical values of the halftone table from an initial pattern having a smaller storage size than that of the halftone table.

The processor may calculate critical values of a single-bit halftone table, and calculate critical values of a multi-bit halftone table from the critical value of the single-bit halftone table.

According to another aspect of the present invention, there is provided an image processing method of converting a gray image into a halftone image, the image processing method including: calculating, by a computer, critical values of a halftone table in positions of the halftone table from an initial pattern that has a smaller storage size than that of the halftone table, the halftone table corresponding to at least one pixel of the gray image, wherein the halftone table is used to apply a halftone process to pixels of the gray image in order to create the halftone image.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an image forming apparatus according to an embodiment of the present invention;

FIG. 2 shows an example to explain a fundamental principle of a halftone process according to an embodiment of the present invention;

FIG. 3 shows another example to explain a fundamental principle of a halftone process according to another embodiment of the present invention;

FIG. 4 is a flowchart of a halftone process in a halftone processing unit according to an embodiment of the present invention;

FIG. 5 is a flowchart of calculating critical values of a halftone table through an initial pattern according to an embodiment of the present invention;

FIG. 6 is a detailed flowchart of calculating critical values of a halftone table from an initial pattern according to an embodiment of the present invention;

FIG. 7 shows an initial pattern according to an embodiment of the present invention;

FIG. 8 shows a pattern obtained by scaling an initial value according to an embodiment of the present invention;

FIG. 9 shows an example of an intermediate value of an intermediate pattern obtained according to an embodiment of the present invention;

FIG. 10 is a flowchart of calculating critical values of a multi-bit halftone table through a single-bit halftone table according to an embodiment of the present invention;

FIG. 11 shows a method of calculating critical values of a multi-bit halftone table from a single-bit halftone table according to an embodiment of the present invention; and

FIG. 12 shows an example of a multi-bit halftone table having critical values calculated according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

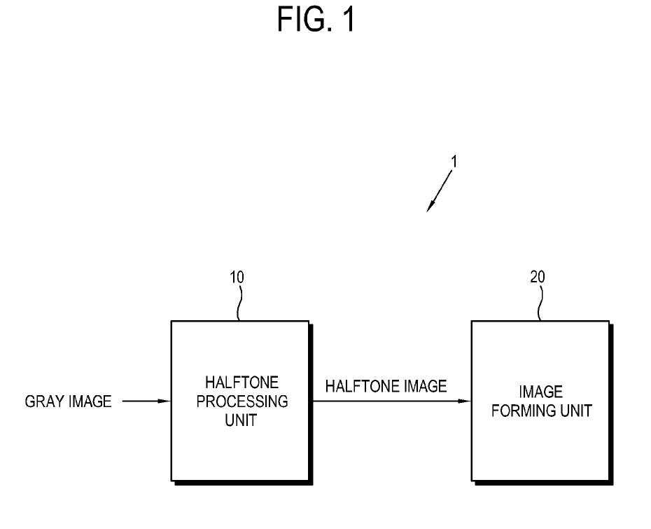

FIG. 1 is a block diagram of an image forming apparatus 1 according to an embodiment of the present invention. The image forming apparatus 1 may be a printer, a facsimile telegraph, a multi-function peripheral, etc. The image forming apparatus 1 receives a gray image to print from a host device (not shown) such as a computer system or the like, and prints an image based on the received gray image onto a print medium (such as a paper, a transparency, etc.), thereby forming an image. In this embodiment, the gray image has a continuous tone that includes a color image and a mono image. The image forming apparatus 1 applies a halftone process to the gray image, thereby converting the gray image into a halftone image.

Referring to FIG. 1, the image forming apparatus 1 includes a halftone processing unit 10 and an image forming unit 20. The halftone processing unit 10 performs the halftone process with regard to the gray image, thereby creating a halftone image. In the present embodiment, the halftone processing unit 10 may include hardware and/or software. For example, the halftone processing unit 10 may include: a non-volatile memory (not shown) such as a read only memory (ROM), a flash memory, etc. in which a software program for a halftone processing method according to an embodiment of the present invention is stored; a volatile memory (not shown) such as a random access memory (RAM) in which the software program stored in the non-volatile memory is loaded; and a processor such as a central processing unit (CPU) to execute the software program loaded in the volatile memory. The processor of the halftone processing unit 10 may be achieved by a single integrated circuit (IC) such as a chip.

The image forming unit 20 prints the halftone image created by the halftone processing unit 10. The image forming unit 20 may perform the printing by an inkjet type, a laser type, etc. The print medium includes plain paper, photo paper, a transparency, etc.

The image forming apparatus 1 may further include at least one of a communication unit (not shown) such as a local communication unit, a network communication unit, etc. to receive a gray image from the host device; a scanning unit (not shown) to scan an object to create the gray image; a facsimile unit (not shown) to receive the gray image from a facsimile telegraph or the like for transmission; and a connecting unit (not shown) to which an external storage device (such as a universal serial bus (USB) memory) storing the gray image is connected. Moreover, the image forming apparatus 1 may further include a control panel (not shown) through which a user inputs a control, and a power supply (not shown) to supply power to respective components of the image forming apparatus 1.

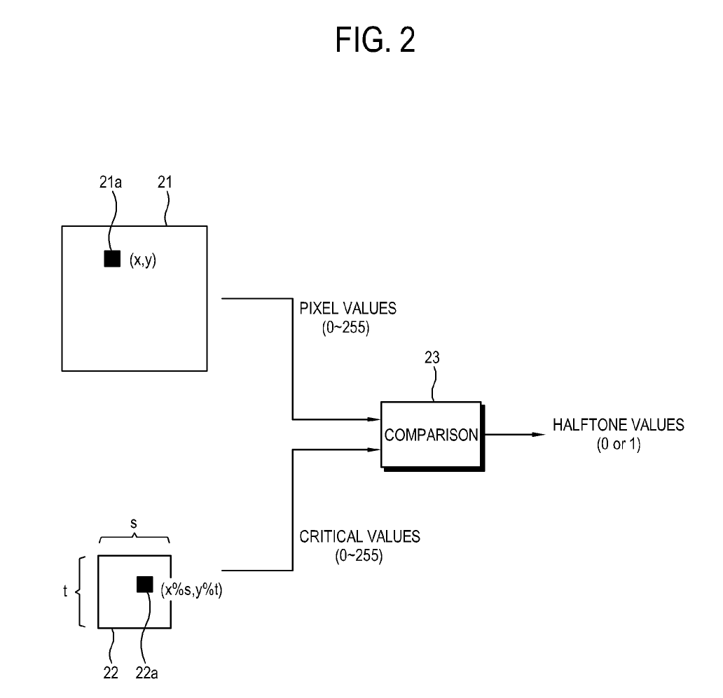

Hereinafter, a halftone process performed in a halftone processing unit 10 according to an embodiment of the present invention will be described. FIG. 2 shows an example to explain a fundamental principle of a halftone process according to an embodiment of the present invention. Referring to FIG. 2, reference numerals of 21 and 22 indicate a gray image and a halftone table, respectively. If one halftone table 22 is used (such as in FIG. 2), the halftone table 22 may be referred to as a “single-bit halftone table” and a halftone image obtained therefrom may be referred to as a “single-bit halftone image.” Also, the halftone process to obtain the single-bit halftone image through the single-bit halftone table may be referred to as a “single-bit halftone process.”

In this embodiment, pixels constituting the gray image 21 are represented by data of 8 bits, and each pixel has a pixel value of 0˜255 gray levels. In this regard, a critical value in the halftone table 22 has one value among 0˜255. Here, the halftone table 22 has a dimension of s*t (where, s and t are natural numbers). The single-bit halftone process is performed by comparing the pixel value of an arbitrary pixel 21a with the critical value 22a of the halftone table 22 corresponding to the pixel 21a. Depending on a comparison result 23, a halftone value (0 or 1) of the halftone image for the arbitrary pixel 21a is determined. Referring to FIG. 2, x and y indicate the position or the coordinates of the pixels 21a in the gray image 21, and x % s and y % t indicate the position or the coordinates of the critical value 22a in the halftone table 22. The halftone process is applied to all pixels of the gray image 21. Accordingly, the halftone values (0 or 1), obtained by applying the halftone process to all pixels of the gray image 21, form a halftone image.

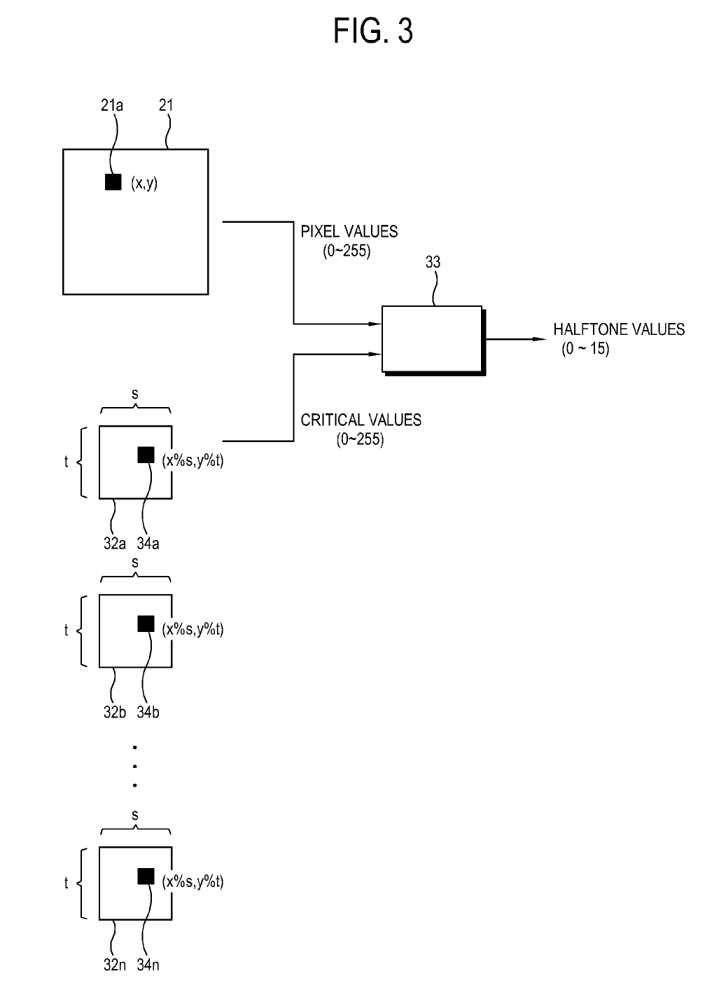

FIG. 3 shows another example to explain a fundamental principle of the halftone process according to another embodiment of the present invention. As opposed to the single-bit halftone table of FIG. 2, FIG. 3 shows that a plurality of halftone tables 32a, 32b, . . . , 32n are used. In this case, the plurality of halftone tables 32a, 32b, . . . , 32n may be referred to as “multi-bit halftone table” and a halftone image obtained therefrom may be referred to as a “multi-bit halftone image.” Also, the halftone process to obtain the multi-bit halftone image through the multi-bit halftone table may be referred to as a “multi-bit halftone process.”

Referring to FIG. 3, reference numerals 34a, 34b, . . . , 34n indicate critical values in the respective multi-bit halftone tables 32a, 32b, . . . , 32n corresponding to the pixel 21a of the gray image 21. In this embodiment, the pixel values of the gray image 21 and the critical values 34a, 34b, . . . , 34n of the multi-bit halftone tables 32a, 32b, . . . , 32n each have one of 0˜255 values (like those of FIG. 2). However, the halftone value of the multi-bit halftone image resulting from the multi-bit halftone process (i.e., a comparison result 33) has a level corresponding to a multi bit. For example, if the multi bit is 4 (i.e., n=4), the halftone value has a value of 0˜15. The multi-bit halftone process is performed by comparing the pixel value of an arbitrary pixel 21a in the gray image 21 with the critical values 34a, 34b, . . . , 34n of the multi-bit halftone tables 32a, 32b, . . . , 32n corresponding to the pixel 21a, respectively.

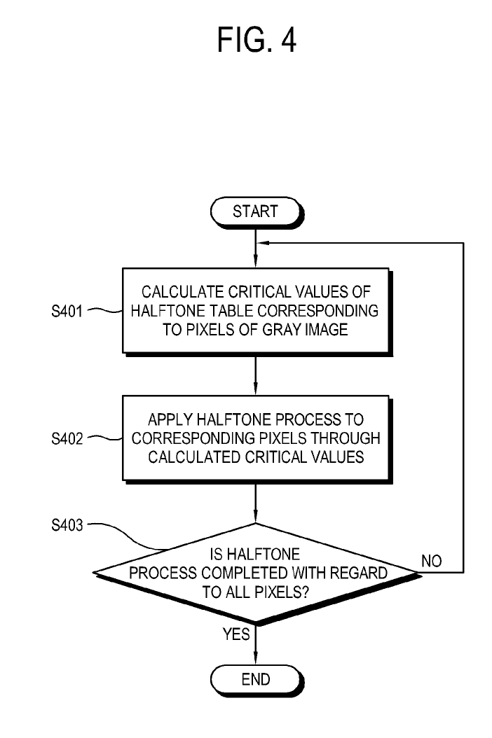

With respect to at least one pixel of the gray pixel, the halftone processing unit 10 according to an embodiment of the present invention directly calculates a critical value of a halftone table corresponding to the pixel by an internal operation of a processor during the halftone process, without using the halftone table stored in an external memory of the processor. FIG. 4 is a flowchart of the halftone process in the halftone processing unit 10 according to an embodiment of the present invention. Referring to FIG. 4, the halftone processing unit 10 calculates a critical value of a halftone table corresponding to one pixel of a gray image to be printed in operation S401. Then, the halftone processing unit 10 obtains the halftone value by applying the halftone process to the one pixel on the basis of the calculated critical value of the halftone table in operation S402. Specifically, the halftone process may include the single-bit halftone process and/or the multi-bit halftone process described with reference to FIGS. 2 and 3, respectively. Then, the halftone processing unit 10 determines whether the halftone process is completed with regard to all pixels in operation S403. If the halftone process is not completed (operation S403), the halftone processing unit 10 returns back to the operation S401 and calculates the critical value of the halftone table with respect to the next pixel of the gray image in the operation S401. If it is determined that the halftone process is completed with regard to all pixels (operation S403), the halftone processing unit 10 finishes the halftone process.

Thus, according to the present embodiment, the critical value of the halftone table is directly calculated during the halftone process (operation S401), and therefore there is no need of a memory to store the previously determined critical value of the halftone table. As a result, a cost of the memory is reduced and the physical size of the memory is minimized, thereby minimizing the size of a chip (if, for example, the halftone processing unit 10 is realized in the form of the chip.

For example, conventionally, a memory has a size of at least 500 Kbyte to store the halftone table (dimension: 181*181) for a color halftone. Conversely, an embodiment of the present invention does not require such a size for the memory. Particularly, during the conventional halftone process, the whole halftone table is loaded into an internal memory (not shown) (such as the SRAM or the like) provided in the chip. In consideration of the characteristics of the internal memory that has a restriction on size, significant costs and design implications may result when decreasing the memory to store the halftone table.

Furthermore, in the case of using the previously made conventional halftone table, the halftone table is transmitted from an external memory (not shown) (such as the DRAM or the like) provided from outside of the chip to the internal memory of the chip. Conversely, according to an embodiment of the present invention, the halftone table is not transmitted from the external memory to the internal memory. Thus, the time for the halftone process is shortened by as much as the time (e.g., about 50 ms) used to transmit the halftone table, thereby speeding up the halftone process.

Hereinafter, a process to calculate the critical values of the halftone table according to an embodiment of the present invention will be described. The method of calculating the critical values of the halftone table may include a method using initial pattern and/or a method using a single-bit halftone table.

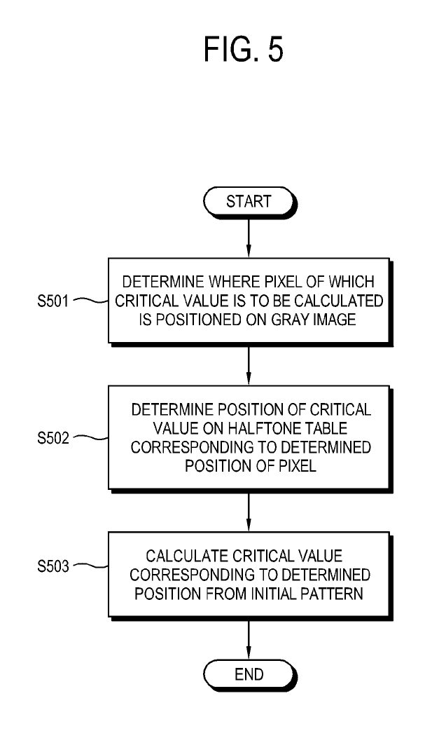

The critical values of the halftone table according to aspects of the present invention may be calculated from a preset initial pattern. The critical values of the halftone table, which can be calculated from the initial pattern, may be the critical values of the single-bit halftone table. The initial pattern used herein may be smaller than the size of the halftone table. FIG. 5 is a flowchart of calculating the critical values of the halftone table through the initial pattern according to an embodiment of the present invention. Referring to FIG. 5, the halftone processing unit 10 determines where a pixel for which a critical value of the halftone table is to be calculated is positioned on the gray image. For example, referring to FIG. 2, the pixel on the gray image may be positioned at coordinates (x, y) of the pixel 21a. The halftone processing unit 10 determines where the critical value corresponding to the determined position of the pixel is positioned on the halftone table in operation S502. For example, referring to FIG. 2, the critical value on the halftone table corresponding to the determined position of the pixel may be positioned at coordinates (x % s, y % t) of the critical value 22a. The halftone processing unit 10 calculates the critical value of the halftone table corresponding to the determined position from the initial pattern in operation S503.

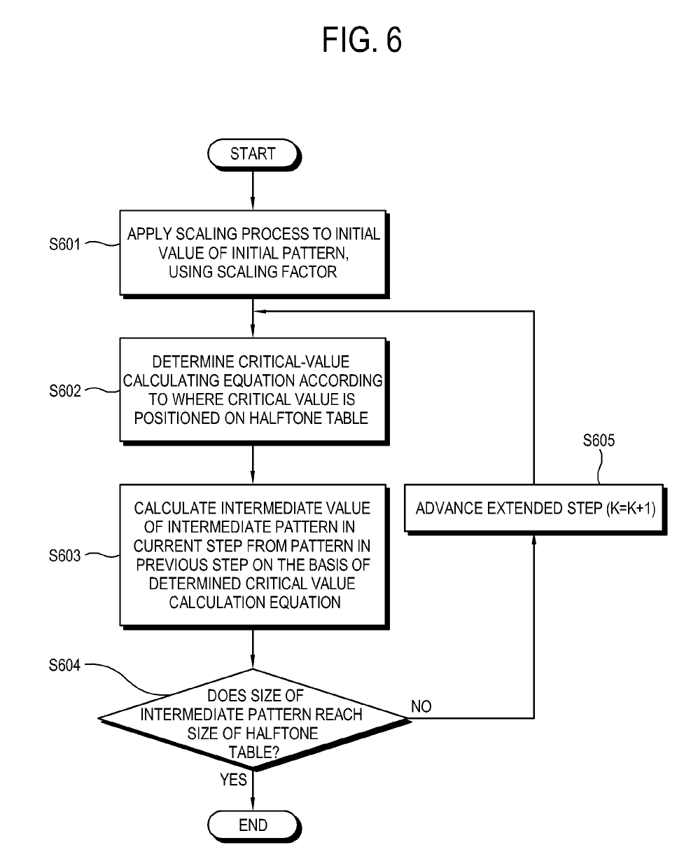

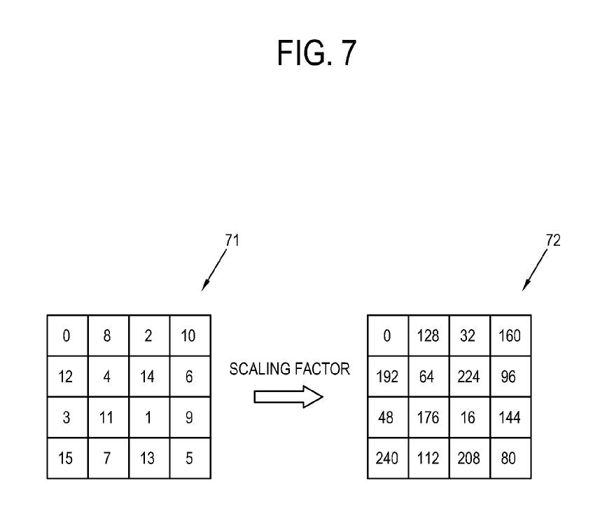

Hereinafter, the calculating of the critical value (operation S503) will be described below in more detail. FIG. 6 is a detailed flowchart of calculating the critical values of the halftone table from the initial pattern according to an embodiment of the present invention. Referring to FIG. 6, the halftone processing unit 10 applies a scaling process to an initial value of the initial pattern through a scaling factor in operation S601. FIG. 7 shows an initial pattern 71 according to an embodiment of the present invention. The initial pattern 71 shown in FIG. 7 has a size of 4*4. Correspondingly, the halftone table according to this embodiment may have a size of 128*128, 256*256, etc. However, the sizes of the initial pattern 71 and the halftone table are not limited thereto, and may be variously selected according to demands in light of design.

Numerals on the initial pattern 71 of FIG. 7 indicate initial values. The initial values of the initial pattern 71 may be determined on the basis of the halftone processing method (such as an ordered dither or the like). In the present embodiment, numerals (4*4=16) within a range of 0˜15 are arranged on the initial pattern 71 by the ordered dither. The initial pattern 71 is previously prepared and stored (for example, in the halftone processing unit 10 or elsewhere in the image forming apparatus 1). According to aspects of the present invention, the size of the initial pattern 71 is smaller than that of the halftone table, and thus the size of the memory to store the initial pattern 71 can be smaller as compared to that occupied with all critical values of the conventional halftone table.

Referring back to FIG. 6, the scaling factor corresponds to a bit level of a gray image to be printed. For example, if the gray image to be printed is of 8 bits (i.e., 256 gray scales), the scaling factor may be determined as 16 so that the initial value of the initial pattern 71 can correspond to 8 bits (i.e., 256 gray scales). That is, the halftone processing unit 10 in the present embodiment multiplies each initial value of the initial pattern 71 by 16 to scale the initial pattern 71, resulting in the scaled initial pattern 72.

The halftone processing unit 10 determines a critical-value calculating equation to be used in consideration of where the critical value to be calculated is positioned on the halftone table in operation S602. The halftone processing unit 10 in this embodiment gradually extends the initial pattern to the size of the halftone table and thus obtains the critical value. In the operation S602, the critical-value calculating equation is used to obtain the value of the pattern extended from the initial pattern.

Hereinafter, for purposes of clarifying the present disclosure, the pattern extended from the initial pattern 72 that is obtained by scaling will be referred to as an “intermediate pattern,” and values of the intermediate pattern will be referred to as an “intermediate value.” The critical-value calculating equation according to an embodiment of the present inventions may be as follows:

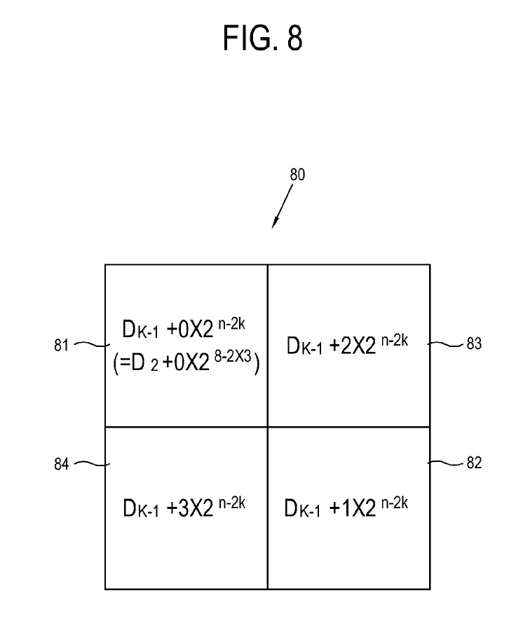

Dₖ=Dₖ₋₁+m×2^{n-2k}, [Equation 1]

where k is a natural number and shows an extended step of a pattern, and Dk and Dk−1 indicate values of the pattern at the kth and (k−1)th steps, respectively. If k=1, the value of the pattern is the initial value of the initial pattern 71 shown in FIG. 7, and if k=2, the value of the pattern is the intermediate value of the intermediate pattern 72 shown in FIG. 7. If k is a value corresponding to the size of the halftone table, Dk is the critical value to be finally obtained. Furthermore, n indicates the size of the pattern in the current step. Also, m is a coefficient selectable among 0, 1, 2 and 3, which is determined according to where the critical value to be obtained is positioned on the halftone table. Below, a method of determining a coefficient m according to an embodiment of the present invention will be described with reference to FIG. 8.

FIG. 8 shows an intermediate pattern 80 in an arbitrary extended step according to an embodiment of the present invention. The intermediate pattern 80 is divided into four regions 81 to 84, and each size of the regions 81 to 84 is the same as the size of the pattern in the previous step. In other words, if one step is extended according to an embodiment of the present invention, the length and the width of the pattern are doubled and the area of the pattern is quadrupled. In this embodiment, the coefficient m is individually allocated to each region 81 to 84. Referring to FIG. 8, as the coefficient m, “0,” “1,” “2” and “3” are allocated to a first region 81, a second region 82, a third region 83 and a fourth region 84, respectively.

To determine the critical-value calculating equation, the coefficient m is determined as follows according to where the critical value to be obtained is positioned on the halftone table in each step of extending the pattern. Here, if the size of the pattern in the previous step is s1*t1, and the positions of the critical values to be obtained on the halftone table (i.e., the coordinates of the critical value) are (x % s, y % t), the coefficient m is determined as follows:

If x % s<=s1 and y % t<=t1, m=0 (1)

If x % s>s1 and y % t>t1, m=1 (2)

If x % s>s1 and y % t<=t1, m=2 (3)

If x % s<=s1 and y % t>t1, m=3 (4)

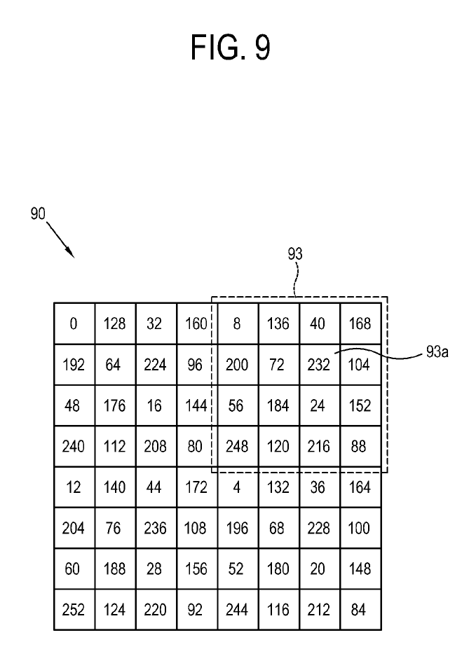

Referring back to FIG. 6, at operation S603 the halftone processing unit 10 obtains the intermediate value of the intermediate pattern in the current step from the pattern in the previous step on the basis of the critical-value calculating equation determined at operation S602. FIG. 9 shows an example of an intermediate value of an intermediate pattern 90 obtained according to an embodiment of the present invention. Referring to FIG. 9, the intermediate value of the intermediate pattern 90 shown in FIG. 9 is calculated from the critical-value calculating equation (refer to [Equation 1]). The pattern in the previous step used in FIG. 9 is the intermediate pattern 72 shown in FIG. 7. In FIG. 9, k=3, and n=8.

To obtain the intermediate value of the intermediate pattern 90 shown in FIG. 9, Dk−1 is a value of the intermediate pattern in the previous pattern corresponding to the position of Dk in the region to which Dk to be obtained belongs. For example, since the intermediate value 93a (“233” in FIG. 9) in the third region 93 is positioned in coordinates (3, 2), Dk−1 corresponding thereto has a value of “224” corresponding to the same coordinates in the previous intermediate pattern 72 of FIG. 7. Thus, if “224” is used for Dk−1 in the critical-value calculating equation (see [Equation 1]), “232” is obtained for Dk as shown in FIG. 9.

Referring back to FIG. 6, after obtaining the intermediate value of the intermediate pattern in the current step (operation S603), the halftone processing unit 10 determines whether the size of the intermediate pattern in the current step reaches the size of the halftone table in operation S604. Accordingly, if the size of the intermediate pattern in the current step does not reach the size of the halftone table (No at operation S604), the halftone processing unit 10 advances the extension by one step (k=k+1) in operation S605 and repeats the operations S602 to S604 again. Conversely, if it is determined at the operation S604 that the size of the intermediate pattern in the current step reaches the size of the halftone table (Yes at operation S604), the halftone processing unit 10 finishes the process of calculating the critical value. In this case, the calculated intermediated value is the critical value to be obtained from the halftone table (operation S402 in FIG. 4).

According to another embodiment of the present invention, the critical value of the halftone table can be calculated from the single-bit halftone table. This method may be applied when obtaining the critical value of the multi-bit halftone table. In this embodiment, the single-bit halftone table may be calculated from the above described initial pattern or may be stored as preset values in a predetermined memory (not shown).

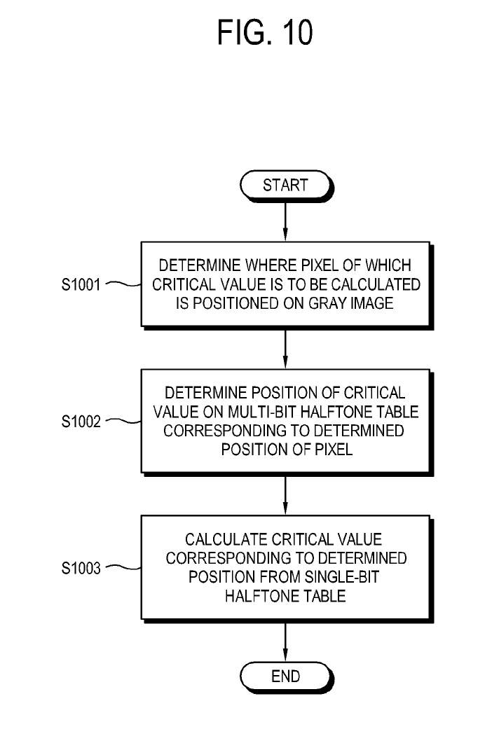

FIG. 10 is a flowchart of calculating critical values of a multi-bit halftone table through a single-bit halftone table according to an embodiment of the present invention. Referring to FIG. 10, the halftone processing unit 10 determines where a pixel for which a critical value of the halftone table is to be calculated is positioned on the gray image in operation S1001. The halftone processing unit 10 determines where the critical value corresponding to the determined position of the pixel is positioned on the halftone table in operation S1002. Accordingly, the halftone processing unit 10 calculates the critical value of the multi-bit halftone table corresponding to the determined position from the single-bit halftone table in operation S1003.

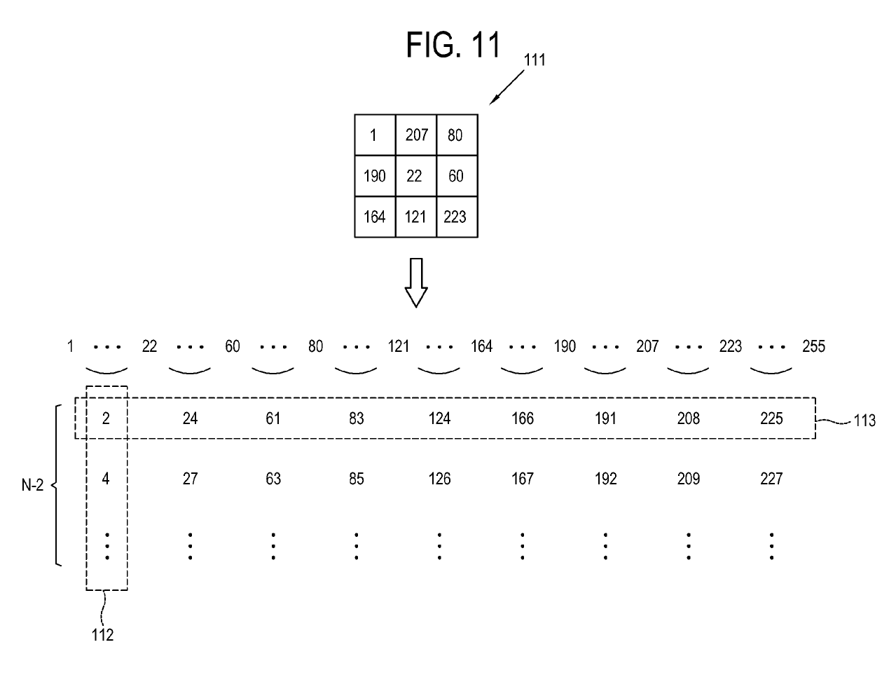

FIG. 11 shows a method of calculating the critical values of the halftone table from the single-bit halftone table according to an embodiment of the present invention. For convenience of description, the size of the single-bit halftone table 111 used in FIG. 11 is 3*3. Also, in FIG. 11, N indicates a multi-level of the multi-bit halftone table. In the present embodiment, the halftone processing unit 10 calculates the critical values of the multi-bit halftone table by interpolating a pair of critical values from the single-bit halftone table 111. The pair of critical values includes a first critical value of the single-bit halftone table corresponding to the position of a critical value to be calculated, and a second critical value next to the first critical value. Referring to FIG. 11, if the critical value to be calculated is positioned at (1, 1) on the multi-bit halftone table, the first critical value corresponding thereto on the single-bit halftone table is “1,” and the second critical value next to the first critical value is “22.” Likewise, if the critical value to be calculated is positioned at (2, 1) on the multi-bit halftone table, the first critical value corresponding thereto on the single-bit halftone table is “207,” and the second critical value next to the first critical value is “223.”

To interpolate between the first critical value and the second critical value, a plurality of critical values having the same position on the plurality of multi-bit halftone tables are determined so as to be distributed between the first critical value and the second critical value. For example, referring to FIG. 11, if the first critical value and the second critical value are “1” and “22,” respectively, the plurality of critical values 115 on the plurality of multi-bit halftone tables may be determined as “2,” “4,” . . . To determine the plurality of critical values 112, a value may be obtained by dividing difference (22−1=21) between the first critical value and the second critical value by the number (N−2) of plural critical values 112. Here, the halftone processing unit 10 uses the single-bit halftone table 111 and the plural critical values 112 to apply the multi-level halftone process to the corresponding pixel.

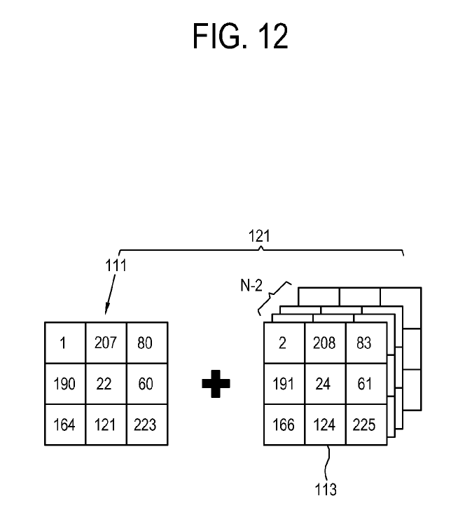

FIG. 12 shows an example of the multi-bit halftone table having the critical values calculated according to an embodiment of the present invention. The interpolated critical values (refer to 113 of FIG. 11) in each row of the single-bit halftone table 111 correspond to one table (refer to 113 of FIG. 12) among the plurality of multi-bit halftone tables 121.

As is apparent from the above description, a memory used to store a halftone table is decreased, thereby reducing a cost of the memory, minimizing restriction on design, and speeding a halftone process up.

While not restricted thereto, aspects of the present invention can also be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Aspects of the present invention may also be realized as a data signal embodied in a carrier wave and comprising a program readable by a computer and transmittable over the Internet.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An image processing method of converting a gray image into a halftone image, the image processing method comprising:
calculating, by a halftone processing unit, critical values of a halftone table in positions of the halftone table from an initial pattern that has a smaller storage size than that of the halftone table, the halftone table corresponding to at least one pixel of the gray image; and
creating, by the halftone processing unit, the halftone image by applying a halftone process to pixels of the gray image on the basis of the calculated critical values of the halftone table.

2. The image processing method as claimed in claim 1, wherein:
the halftone image comprises a single-bit halftone image; and
the halftone table comprises a single-bit halftone table corresponding to the single-bit halftone image.

3. The image processing method as claimed in claim 2, wherein the calculating of the critical values comprises applying a scaling process to an initial value of the initial pattern, using a scaling factor corresponding to a bit level of the gray image to create a scaled initial pattern.

4. The image processing method as claimed in claim 3, wherein the calculating of the critical values further comprises extending the scaled initial pattern, by one or more steps, based on a critical-value calculating equation determined for a critical value, of the critical values of the halftone table, according to where the critical value is positioned on the single-bit halftone table.

5. The image processing method as claimed in claim 4, wherein the critical-value calculating equation is:
Dₖ=Dₖ₋₁+m×2^{n-2k},
where k is a natural number equal to a value of a step, of the one or more steps, Dk and Dk−1 indicate values of the pattern at the kth and (k−1)th steps, respectively, n indicates a size of the pattern in the kth step, and m is a coefficient determined according to where the critical value is positioned on the halftone table.

6. The image processing method as claimed in claim 5, wherein:
m=0 when the critical value is positioned at a first region of the halftone table;
m=1 when the critical value is positioned at a second region of the halftone table;
m=2 when the critical value is positioned at a third region of the halftone table;
m=3 when the critical value is positioned at a fourth region of the halftone table; and
the first, second, third, and fourth regions are different from each other.

7. The image processing method as claimed in claim 2, wherein:
the halftone image further comprises a multi-bit halftone image; and
the halftone table further comprises a plurality of multi-bit halftone tables corresponding to the multi-bit halftone image.

8. The image processing method as claimed in claim 7, wherein the calculating of the critical values of the halftone table further comprises calculating the critical values of the plurality of multi-bit halftone tables using the calculated critical values of the single-bit halftone table.

9. The image processing method as claimed in claim 8, wherein the calculating of the critical values of the plurality of multi-bit halftone tables comprises interpolating a pair of critical values of the single-bit halftone table.

10. The image processing method as claimed in claim 9, wherein the pair of critical values comprises a first critical value of the single-bit halftone table corresponding to a position of a critical value to be calculated, and a second critical value next in value to the first critical value.

11. The image processing method as claimed in claim 10, wherein the calculating of the critical values of the plurality of multi-bit halftone tables further comprises determining a plurality of corresponding critical values of a same position on the plurality of respective multi-bit halftone tables to be distributed between the first critical value and the second critical value corresponding to the same position.

12. The image processing method as claimed in claim 11, wherein the calculating of the critical values comprises:
determining where a pixel of which a critical value is to be calculated is positioned on the gray image;
determining a position of the critical value on the halftone table according to the determined position of the pixel; and
calculating the critical value corresponding to the determined position from the initial pattern.

13. A computer-readable recording medium encoded with the method of claim 1 and implemented by at least one computer.

14. An image forming apparatus to convert a gray image into a halftone image, the image forming apparatus comprising:
a halftone processing unit to calculate critical values of a halftone table in positions of the halftone table from an initial pattern that has a smaller storage size than that of the halftone table, the halftone table corresponding to at least one pixel of the gray image, and to create the halftone image by applying a halftone process to pixels of the gray image on the basis of the calculated critical values of the halftone table.

15. The image forming apparatus as claimed in claim 14, further comprising:
an image forming unit to form an image on a print medium according to the created halftone image.

16. The image forming apparatus as claimed in claim 14, wherein:
the halftone image comprises a single-bit halftone image; and
the halftone table comprises a single-bit halftone table corresponding to the single-bit halftone image.

17. The image forming apparatus as claimed in claim 16, wherein the halftone processing unit applies a scaling process to an initial value of the initial pattern, using a scaling factor corresponding to a bit level of the gray image to create a scaled initial pattern.

18. The image forming apparatus as claimed in claim 17, wherein the halftone processing unit extends the scaled initial pattern, by one or more steps, based on a critical-value calculating equation determined for a critical value, of the critical values of the halftone table, according to where the critical value is positioned on the single-bit halftone table.

19. The image forming apparatus as claimed in claim 18, wherein the critical-value calculating equation is:
Dₖ=Dₖ₋₁+m×2^{n-2k},
where k is a natural number equal to a value of a step, of the one or more steps, Dk and Dk−1 indicate values of the pattern at the kth and (k−1)th steps, respectively, n indicates a size of the pattern in the kth step, and m is a coefficient determined according to where the critical value is positioned on the halftone table.

20. The image forming apparatus as claimed in claim 19, wherein:
m=0 when the critical value is positioned at a first region of the halftone table;
m=1 when the critical value is positioned at a second region of the halftone table;
m=2 when the critical value is positioned at a third region of the halftone table;
m=3 when the critical value is positioned at a fourth region of the halftone table; and
the first, second, third, and fourth regions are different from each other.

21. The image forming apparatus as claimed in claim 16, wherein:
the halftone image further comprises a multi-bit halftone image; and
the halftone table further comprises a plurality of multi-bit halftone tables corresponding to the multi-bit halftone image.

22. The image forming apparatus as claimed in claim 21, wherein the halftone processing unit calculates the critical values of the plurality of multi-bit halftone tables using the calculated critical values of the single-bit halftone table.

23. The image forming apparatus as claimed in claim 22, wherein the halftone processing unit interpolates a pair of critical values of the single-bit halftone table.

24. The image forming apparatus as claimed in claim 23, wherein the pair of critical values comprises a first critical value of the single-bit halftone table corresponding to a position of a critical value to be calculated, and a second critical value next in value to the first critical value.

25. The image forming apparatus as claimed in claim 24, wherein the halftone processing unit determines a plurality of corresponding critical values of a same position on the plurality of respective multi-bit halftone tables to be distributed between the first critical value and the second critical value corresponding to the same position.

26. An image processing method of converting a gray image into a halftone image through a processor, the image processing method comprising:
calculating critical values of a halftone table corresponding to at least one pixel of the gray image by internal operations of the processor; and
creating the halftone image by applying a halftone process to pixels of the gray image, using the calculated critical values of the halftone table.

27. The image processing method according to claim 26, wherein the calculating of the critical values of the halftone table comprises calculating the critical values of the halftone table from an initial pattern having a smaller storage size than that of the halftone table.

28. The image processing method according to claim 27, wherein the calculating of the critical values of the halftone table from the initial pattern comprises:
calculating critical values of a single-bit halftone table.

29. The image processing method as claimed in claim 28, wherein the calculating of the critical values of the halftone table from the initial pattern further comprises calculating critical values of a multi-bit halftone table from the calculated critical values of the single-bit halftone table.

30. A computer-readable recording medium encoded with the method of claim 26 and implemented by at least one computer.

31. An image forming apparatus to convert a gray image into a halftone image, the image forming apparatus comprising:
a processor to calculate critical values of a halftone table corresponding to at least one pixel of the gray image and to create the halftone image by applying a halftone process to pixels of the gray image, using the calculated critical values of the halftone table.

32. The image forming apparatus as claimed in claim 31, further comprising:
an image forming unit to form an image on a print medium according to the created halftone image.

33. The image forming apparatus as claimed in claim 31, wherein the processor calculates the critical values of the halftone table from an initial pattern having a smaller storage size than that of the halftone table.

34. The image forming apparatus as claimed in claim 33, wherein the processor calculates critical values of a single-bit halftone table.

35. The image forming apparatus as claimed in claim 34, wherein the processor calculates critical values of a multi-bit halftone table from the calculated critical values of the single-bit halftone table.

36. An image processing method of converting a gray image into a halftone image, the image processing method comprising:
calculating, by a halftone processing unit, critical values of a halftone table in positions of the halftone table from an initial pattern that has a smaller storage size than that of the halftone table, the halftone table corresponding to at least one pixel of the gray image,
wherein the halftone table is used to apply a halftone process to pixels of the gray image in order to create the halftone image.

37. A computer-readable recording medium encoded with the method of claim 36 and implemented by at least one computer.
